(19) United States
(12) Patent Application Publication
(10) Pub. No.: US 2025/0019527 A1
(43) Pub. Date: Jan. 16, 2025

(54) RUBBER MIXTURE COMPRISING A RAPID VULCANIZATION ACCELERATOR

(71) Applicant: COMPAGNIE GENERALE DES ETABLISSEMENTS MICHELIN, Clermont-Ferrand (FR)

(72) Inventors: MAXIME PRAS, Clermont-Ferrand (FR); JOSE-CARLOS ARAUJO DA SILVA, Clermont-Ferrand (FR); STEPHANE BADAIRE, Clermont-Ferrand (FR); SIMON DURIEZ, Clermont-Ferrand (FR)

(21) Appl. No.: 18/713,504

(22) PCT Filed: Nov. 24, 2022
(86) PCT No.: PCT/EP2022/083134

§ 371 Date: May 24, 2024

(30) Foreign Application Priority Data
Nov. 26, 2021 (FR) 2112589

(51) Int. Cl. C08L 9/06; B60C 1/00; C08K 3/013; C08K 5/40

(52) U.S. Cl. CPC C08L 9/06; B60C 1/0016; C08K 3/013; C08K 5/40; C08L 2205/025

(57) ABSTRACT

A rubber compound has at least two glass transition temperatures Tg1 and Tg2, based on at least one vulcanization system and at least two rubber compositions C1 and C2, the composition C1 comprising at least one elastomer E1 and having a Tg1, the composition C2 comprising at least one elastomer E2 different from E1, and a reinforcing filler, and the composition C2 having a Tg2, in which: Tg1≥−50° C.; the rubber compound satisfies Tg1-Tg2≥23° C.; the rubber compound has a loss factor profile which is such that all the tan δ peaks present at a temperature above the temperature Tg1 have a width at half height of ≤23° C.; E1 is predominant in the rubber compound; E2 is an isoprene diene elastomer; and the vulcanization system comprises at least one vulcanization accelerator A selected from thiurams, dithiocarbamates, dithiophosphates, xanthates and mixtures thereof.

The field of the present invention is that of reinforced rubber compounds, notably used in the manufacture of tyres for vehicles, more particularly used for the manufacture of treads.

One of the requirements needed for a tyre is to provide optimal grip on the road, especially on wet ground. One way of giving the tyre increased grip on wet ground is to use a rubber composition in its tread, which composition has a broad hysteresis potential. But at the same time, the tyre tread must also minimize its contribution to the rolling resistance of the tyre, that is to say have the lowest possible hysteresis.

Thus, the rubber composition, notably of the tread, must satisfy two conflicting requirements, namely having a maximum hysteresis potential in order to satisfy the requirement of grip and having a hysteresis that is as low as possible in order to satisfy the requirement of rolling resistance.

Improving the rolling resistance has been made possible by virtue of the use of novel rubber compositions reinforced with inorganic fillers, in particular specific silicas of the highly dispersible type, which are capable of rivalling, from the reinforcing perspective, a conventional tyre-grade carbon black, while offering these compositions a lower hysteresis, which is synonymous with a lower rolling resistance.

However, the use of a high content of inorganic reinforcing fillers in the rubber compositions has the disadvantage of adversely affecting the wet grip properties of the rubber compositions in which they are incorporated.

Satisfying both the requirement of grip, especially on wet ground, and of rolling resistance thus remains a constant concern of tyre manufacturers.

In order to seek the best compromise in performance, in particular between rolling resistance and grip on wet surfaces, tyre manufacturers are developing increasingly complex rubber compositions, often incorporating several elastomers of different chemical nature thus forming a rubber compound and creating different phases. Examples of complex rubber compounds are described in document FR20/05862 belonging to the applicant. In this document, these complex rubber compounds are defined by two glass transition temperatures denoted Tg1 and Tg2 with Tg1-Tg2≥23° C., and by a specific loss factor profile which is measured over a temperature range extending from −80° C. to 60° C. at a frequency of 10 Hz and a specific constant stress of 0.7 MPa; these complex rubber compounds exhibit an improvement in the rolling resistance/wet grip compromise.

Continuing its research, the applicant has sought to even further improve this resistance compromise for these certain of its complex rubber compounds.

It has surprisingly discovered that a rubber compound having a particular loss factor profile, the loss factor profile being measured over a temperature range extending from −80° C. to 60° C. at a frequency of 10 Hz and a constant stress of 0.7 MPa, and being based on a combination of at least one specific vulcanization system and of at least two rubber compositions C1 and C2 having different glass transition temperatures and for which the difference in these glass transition temperatures is above or equal to 23° C. and in which the elastomer of the composition C1 is predominant in the mixture, the elastomer of the composition C2 being an isoprene diene elastomer and the vulcanization system comprising a specific ultra-accelerator, exhibited better rolling resistance while retaining good wet grip properties, or even improved grip properties.

Thus, a first subject of the invention relates to a rubber compound having at least two glass transition temperatures Tg, namely Tg1 and Tg2, based on at least one sulfur vulcanization system and at least two rubber compositions C1 and C2, the rubber composition C1 comprising at least one elastomer E1 and having the glass transition temperature Tg1, the composition C2 comprising at least one elastomer E2, different from the elastomer E1, and a reinforcing filler, and the composition C2 having the glass transition temperature Tg2, characterized in that:
the glass transition temperature Tg1 of the composition C1 is above or equal to −50° C.;
the rubber compound satisfies the mathematical relationship Tg1-Tg2≥23° C.;
the rubber compound has a loss factor profile exhibiting the change in tan δ as a function of the temperature in ° C., the loss factor profile being measured over a temperature range extending from −80° C. to 60° C. at a frequency of 10 Hz and a constant stress of 0.7 MPa and exhibiting one or more peaks, this profile being such that all the tan δ peaks present at a temperature above the glass transition temperature Tg1 have a width at half height below or equal to 23° C.;
the elastomer E1 is predominant in the rubber compound;
the elastomer E2 is an isoprene diene elastomer; and
the sulfur vulcanization system comprises at least one vulcanization accelerator A selected from the group consisting of thiurams, dithiocarbamates, dithiophosphates, xanthates and mixtures thereof.

Preferentially, the rubber compound satisfies the mathematical relationship Tg1-Tg2≥25° C., preferably Tg1-Tg2≥28° C.

Advantageously, the rubber compound can satisfy the mathematical relationship 25° C.≤Tg1-Tg2≤40° C.

Advantageously, the glass transition temperature Tg2 of the composition C2 may be below or equal to −43° C., preferably below or equal to −50° C.

Advantageously, the glass transition temperature Tg2 of composition C2 is within a range extending from −90° C. to −43° C., preferably extending from −85° C. to −50° C.

Advantageously, the elastomer E2 of the rubber composition C2 is an isoprene diene elastomer selected from the group consisting of natural rubber and synthetic polyisoprene, even more preferentially natural rubber.

Advantageously, the glass transition temperature TgE2 of the elastomer E2 may be within a range extending from −110° C. to −23° C., preferably extending from −100° C. to −28° C., more preferentially extending from −95° C. to −30° C.

Preferentially, the reinforcing filler of the composition C2 may predominantly comprise at least one inorganic reinforcing filler, more preferentially may predominantly comprise at least one silica.

Advantageously, the reinforcing filler of the composition C2 may predominantly comprise a reinforcing inorganic filler, preferentially predominantly a silica, and the isoprene diene elastomer E2 may be natural rubber.

Advantageously, the glass transition temperature Tg1 of the rubber composition C1 may be within a range extending from −48° C. to −15° C., more preferentially may be within a range extending from −40° C. to −15° C.

Advantageously, the glass transition temperature Tg1 of the rubber composition C1 may be above or equal to −48° C., preferably above or equal to −40° C.

Advantageously, the elastomer E1 of the rubber composition C1 may be a diene elastomer. Preferably, the elastomer E1 of the rubber composition C1 is a non-functionalized diene elastomer.

Advantageously, the elastomer E1 of the rubber composition C1 is a diene elastomer selected from the group consisting of polybutadienes, butadiene/styrene copolymers, butadiene/isoprene copolymers, isoprene/styrene copolymers and butadiene/styrene/isoprene copolymers, and mixtures thereof. Preferentially, the elastomer E1 of the rubber composition C1 is a diene elastomer selected from the group consisting of polybutadienes, butadiene/styrene copolymers, and mixtures thereof. More preferentially still, the elastomer E1 of the composition C1 is a styrene/butadiene copolymer, which is notably non-functionalized.

Advantageously, the glass transition temperature TgE1 of the elastomer E1 may be within a range extending from −50° C. to 0° C., more preferentially from −40° C. to 0° C., more preferentially from −30° C. to 0° C.

Advantageously, the content of the elastomer E1 in the rubber compound may be within a range extending from 50 phr to 70 phr, preferably from 55 phr to 70 phr, more preferentially from 55 phr to 65 phr.

Advantageously, the composition C1 may further comprise a reinforcing filler.

Advantageously, the rubber compound may comprise at least one plasticizer.

Advantageously, the rubber compound as defined above and its preferred embodiments can be obtained according to a manufacturing process which comprises the following steps:
preparing the rubber composition C1 in an internal mixer by introducing the elastomer E1 of the rubber composition C1 and, where appropriate, the other ingredients such as a plasticizer and carrying out thermomechanical working up to a maximum temperature of 200° C. in order to obtain the rubber composition C1;
preparing the rubber composition C2 in an internal mixer by introducing the elastomer E2, isoprene diene elastomer, of the rubber composition C2, the reinforcing filler, where appropriate the other ingredients such as a plasticizer or a coupling agent for the reinforcing filler, and carrying out thermomechanical working up to a maximum temperature of 200° C. in order to obtain the rubber composition C2;
introducing the rubber compositions C1 and C2 obtained in the preceding steps into an internal mixer and carrying out thermomechanical working up to a maximum temperature of 180° C. in order to obtain a combination of compositions;
recovering the combination of compositions from the preceding step and cooling it to a temperature below or equal to 110° C.;
incorporating, into the cold combination of compositions, the sulfur vulcanization system; the vulcanization system at least one vulcanization accelerator A selected from the group consisting of thiurams, dithiocarbamates, dithiophosphates, xanthates and mixtures thereof, and kneading this mixture up to a maximum temperature below 110° C., preferentially below 80° C., and recovering the rubber compound.

Another subject of the present invention relates to a tread of a pneumatic or non-pneumatic tyre comprising at least one rubber compound defined above.

Another subject of the present invention relates to a pneumatic or non-pneumatic tyre comprising at least one rubber compound defined above or comprising at least one tread defined above.

The expression “rubber compound based on at least” should be understood to mean a combination of at least two rubber compositions. The rubber compound can thus be in the completely or partially crosslinked state or in the non-crosslinked state.

The expression “rubber composition based on” should be understood to mean a composition comprising the mixture and/or the product of the in situ reaction of the various constituents used, some of these constituents being able to react and/or being intended to react with one another, at least partially, during the various phases of manufacture of the composition; it thus being possible for the composition to be in the completely or partially crosslinked state or in the non-crosslinked state.

For the purposes of the present invention, the expression “part by weight per hundred parts by weight of elastomer” (or phr) should be understood to mean the part by mass per hundred parts by mass of elastomers in the rubber compound.

In the present text, unless expressly indicated otherwise, all the percentages (%) indicated are mass percentages (%).

Furthermore, any interval of values denoted by the expression “between a and b” represents the range of values extending from more than a to less than b (i.e. limits a and b excluded), whereas any interval of values denoted by the expression “from a to b” means the range of values extending from a up to b (i.e. including the strict limits a and b).

When reference is made to a “predominant” compound, this is understood to mean, for the purposes of the present invention, that this compound is predominant among the compounds of the same type in the rubber compound, that is to say that it is the one which represents the greatest amount by weight among the compounds of the same type. Thus, for example, a predominant elastomer is the elastomer representing the greatest weight relative to the total weight of the elastomers of the compound. In the same way, a “predominant” filler is the one representing the greatest weight among the fillers of the compound. By way of example, in a system comprising only one elastomer, the latter is predominant for the purposes of the present invention, and in a system comprising two elastomers, the predominant elastomer represents more than half of the mass of the elastomers. On the contrary, a “minor” compound is a compound which does not represent the greatest fraction by mass among the compounds of the same type. Preferably, the term “predominant” means present to more than 50%, preferably more than 60%, 70%, 80%, 90%, and more preferentially the “predominant” compound represents 100%.

The compounds mentioned in the description may be of fossil origin or may be biobased. In the latter case, they may be partially or totally derived from biomass or may be obtained from renewable starting materials derived from biomass. Obviously, the compounds mentioned May also be derived from the recycling of already-used materials, i.e. they may be partially or totally derived from a recycling process, or obtained from raw materials which are themselves derived from a recycling process. They notably include polymers, plasticizers, fillers, etc.

The glass transition temperatures, denoted Tg1 and Tg2, of the rubber compound of the invention are measured according to Standard NF EN ISO 11357-2:05-2014 on the rubber compound.

The glass transition temperatures of the elastomers, denoted TgE1 and TgE2, are measured according to Standard ASTM D3418:2008 on elastomers.

The loss factor, also referred to as tan δ (also written tan delta), is a physical quantity well known to manufacturers of pneumatic tyres. The loss factor represents the fraction of energy dissipated during a cyclic stress.

The loss factor profile represents the change in the loss factor, tan δ, as a function of the temperature when a constant stress is exerted at a given frequency. Within the context of the present invention, the loss factor profile is measured over a temperature range extending from −80° C. to 60° C. at a frequency of 10 Hz and a constant stress of 0.7 MPa according to Standard ASTM D 5992-96.

### Ingredients of the Rubber Compositions C1 and C2

The rubber compositions C1 and C2 forming the rubber compound according to the invention each comprise at least one elastomer, respectively elastomer E1 and diene elastomer E2; the elastomer E1 being different from the diene elastomer E2; that is to say that the elastomer E1 does not have the same chemical nature as the diene elastomer E2.

An “elastomer” is understood to mean a polymer which is flexible and deformable, exhibiting rubber-like elasticity according to the IUPAC definition of elastomers. Preferably, the elastomers E1 and E2 which can be used in the context of the present invention are random elastomers.

Preferentially, the elastomer E1 of the rubber composition C1 is a diene elastomer.

“Diene” elastomer (or, without distinction, rubber), whether natural or synthetic, is given to mean, as is known, an elastomer at least partially composed (i.e. a homopolymer or a copolymer) of diene monomer units (monomers bearing two conjugated or non-conjugated carbon-carbon double bonds).

An “elastomeric matrix” is understood to mean all of the elastomers forming the rubber compound of the invention.

Diene elastomers can be classified in two categories: “essentially unsaturated” or “essentially saturated”. “Essentially unsaturated” is generally understood to mean a diene elastomer derived at least in part from conjugated diene monomers having a content of units of diene origin (conjugated dienes) which is greater than 15% (mol %); thus, diene elastomers such as butyl rubbers or copolymers of dienes and of α-olefins of EPDM type do not fall under the preceding definition and may especially be termed “essentially saturated” diene elastomers (low or very low content, always less than 15%, of units of diene origin).

A diene elastomer capable of being used in the rubber compounds in accordance with the invention is intended more particularly to mean:
any homopolymer of a conjugated or non-conjugated diene monomer containing from 4 to 18 carbon atoms;
any copolymer of a conjugated or non-conjugated diene containing from 4 to 18 carbon atoms and of at least one other monomer.

The other monomer may be an olefin or a conjugated or non-conjugated diene.

Conjugated dienes that are suitable include conjugated dienes containing from 4 to 12 carbon atoms, in particular 1,3-dienes, notably such as 1,3-butadiene and isoprene.

Non-conjugated dienes that are suitable include non-conjugated dienes containing from 6 to 12 carbon atoms, such as 1,4-hexadiene, ethylidenenorbornene or dicyclopentadiene.

Olefins that are suitable include vinylaromatic compounds containing from 8 to 20 carbon atoms and aliphatic α-monoolefins containing from 3 to 12 carbon atoms.

Vinylaromatic compounds that are suitable include, for example, styrene, ortho-, meta- or para-methylstyrene, the “vinyltoluene” commercial mixture or para-(tert-butyl) styrene.

More particularly, the diene elastomer is:
any homopolymer of a conjugated diene monomer, notably any homopolymer obtained by polymerization of a conjugated diene monomer containing from 4 to 12 carbon atoms;
any copolymer obtained by copolymerization of one or more conjugated dienes with each other or with one or more vinylaromatic compounds containing from 8 to 20 carbon atoms;
a copolymer of isobutene and of isoprene (butyl rubber) and also the halogenated versions, in particular chlorinated or brominated versions, of this type of copolymer.

### Reinforcing Filler

The rubber composition C2 comprises one or more reinforcing fillers.

According to one embodiment of the invention, the rubber composition C1 can optionally also comprise one or more reinforcing fillers. In this embodiment, the content of reinforcing filler of the composition C1 is less than the content of reinforcing filler of the composition C2.

Use may be made of any type of “reinforcing” filler known for its abilities to reinforce a rubber composition which can be used in particular in the manufacture of pneumatic tyres, for example an organic filler, such as carbon black, an inorganic filler, such as silica, or else a mixture of these two types of fillers.

All carbon blacks, in particular the blacks conventionally used in pneumatic tyres or non-pneumatic tyres or their treads, are suitable as carbon blacks. Mention will more particularly be made, among the latter, of the reinforcing carbon blacks of the 200 series such as, for example, the N234 blacks. These carbon blacks may be used in isolated form, as commercially available, or in any other form, for example as support for some of the rubber engineering additives used. The carbon blacks might, for example, be already incorporated in the diene elastomer (see, for example, applications WO97/36724-A2 and WO99/16600-A1).

Mention may be made, as examples of organic fillers other than carbon blacks, of functionalized polyvinyl organic fillers, as described in applications WO2006/069792-A1, WO2006/069793-A1, WO2008/003434-A1 and WO2008/003435-A1.

The term “reinforcing inorganic filler” should be understood here as meaning any inorganic or mineral filler, whatever its colour and its origin (natural or synthetic), also referred to as “white” filler, “clear” filler or even “non-black” filler, in contrast to carbon black, capable of reinforcing, by itself alone, without means other than an intermediate coupling agent, a rubber composition intended for the manufacture of pneumatic or non-pneumatic tyres. In a known manner, some reinforcing inorganic fillers may notably be characterized by the presence of hydroxyl (—OH) groups at their surface.

Mineral fillers of the siliceous type, preferentially silica (SiO₂), or of the aluminous type, especially alumina (Al₂O₃), are suitable in particular as reinforcing inorganic fillers.

The silica used may be any reinforcing silica known to those skilled in the art, notably any precipitated or fumed silica with a BET specific surface area and also a CTAB specific surface area both of less than 450 m²/g, preferably in a range extending from 30 to 400 m²/g, notably from 60 to 300 m²/g. Use may be made of any type of precipitated silica, notably highly dispersible silicas (HDS). These precipitated silicas, which may or may not be highly dispersible, are well known to those skilled in the art. Mention may be made, for example, of the silicas described in applications WO 03/016215-A1 and WO 03/016387-A1. Use may in particular be made, among commercial HDS silicas, of the Ultrasil® 5000GR and Ultrasil® 7000GR silicas from Evonik or the Zeosil® 1085GR, Zeosil® 1115 MP, Zeosil® 1165MP, Zeosil® Premium 200MP and Zeosil® HRS 1200 MP silicas from Solvay. Use may be made, as non-HDS silicas, of the following commercial silicas: the Ultrasil® VN2GR and Ultrasil® VN3GR silicas from Evonik, the Zeosil® 175GR silica from Solvay or the Hi-Sil EZ120G(-D), Hi-Sil EZ160G(-D), Hi-Sil EZ200G(-D), Hi-Sil 243LD, Hi-Sil 210 and Hi-Sil HDP 320G silicas from PPG.

The physical state in which the reinforcing inorganic filler is provided is not important, whether it be in the form of a powder, micropearls, granules, or beads or any other appropriate densified form. Needless to say, the term “reinforcing inorganic filler” also refers to mixtures of different reinforcing inorganic fillers, in particular of silicas as described above.

Those skilled in the art will understand that, as replacement for the reinforcing inorganic filler described above, use might be made of a reinforcing filler of another nature, provided that this reinforcing filler of another nature is covered with an inorganic layer, such as silica, or else comprises functional sites, in particular hydroxyl sites, at its surface which require the use of a coupling agent in order to establish the bond between this reinforcing filler and the elastomeric matrix.

Those skilled in the art will know how to adjust the total content of reinforcing filler depending on the use in question of the rubber compound of the invention, in particular depending on the type of pneumatic tyres in question, for example a pneumatic tyre for a motorcycle, for a passenger vehicle or else for a utility vehicle, such as a van or heavy-duty vehicle.

In the present disclosure, the BET specific surface area is determined by gas adsorption using the Brunauer-Emmett-Teller method described in “The Journal of the American Chemical Society”, (vol. 60, page 309, February 1938), and more specifically according to a method derived from Standard NF ISO 5794-1, appendix E, of June 2010 [multipoint (5 point) volumetric method—gas:nitrogen—degassing under vacuum: one hour at 160° C.—relative pressure p/po range: 0.05 to 0.17]. For inorganic fillers such as silica, for example, the CTAB specific surface area values were determined according to Standard NF ISO 5794-1, appendix G of June 2010. The process is based on the adsorption of CTAB (N-hexadecyl-N,N,N-trimethylammonium bromide) to the “outer” surface of the reinforcing filler. For carbon blacks, the STSA specific surface area is determined according to Standard ASTM D6556-2016.

### Coupling Agents for the Reinforcing Filler:

As is known, in order to couple the reinforcing filler, use may be made of an at least bifunctional coupling agent (or bonding agent) intended to provide a satisfactory connection, of chemical and/or physical nature, between the inorganic filler (surface of its particles) and the diene elastomer. Use is made in particular of organosilanes or polyorganosiloxanes which are at least bifunctional. The term “bifunctional” is understood to mean a compound having a first functional group capable of interacting with the inorganic filler and a second functional group capable of interacting with the elastomer, preferably diene elastomer. For example, such a bifunctional compound can comprise a first functional group comprising a silicon atom, said first functional group being capable of interacting with the hydroxyl groups of an inorganic reinforcing filler, and a second functional group comprising a sulfur atom, said second functional group being capable of interacting with the elastomer, preferably diene elastomer.

Preferentially, the organosilanes are selected from the group consisting of organosilane polysulfides (symmetrical or asymmetrical), such as bis(3-triethoxysilylpropyl) tetrasulfide, abbreviated to TESPT, sold under the name Si69 by Evonik, or bis(3-triethoxysilylpropyl) disulfide, abbreviated to TESPD, sold under the name Si75 by Evonik, polyorganosiloxanes, mercaptosilanes, blocked mercaptosilanes, such as S-(3-(triethoxysilyl) propyl) octanethioate, sold by Momentive under the name NXT Silane. More preferentially, the organosilane is an organosilane polysulfide.

Needless to say, use might also be made of mixtures of the coupling agents described previously.

### Covering Agents

The rubber compositions forming the rubber compound of the invention can also contain agents for covering the reinforcing inorganic filler when a reinforcing inorganic filler is used in a composition of the compound of the invention, making it possible to improve their processability in the uncured state. These covering agents are well known (see, for example, patent applications WO 2006/125533-A1, WO 2007/017060-A1 and WO 2007/003408-A1); mention will be made, for example, of hydrolysable silanes such as hydroxysilanes (see, for example, WO 2009/062733-A2), alkylalkoxysilanes, polyols (for example diols or triols), polyethers (for example polyethylene glycols), primary, secondary or tertiary amines, hydroxylated or hydrolysable polyorganosiloxanes (for example α,ω-dihydroxypolyorganosilanes (see, for example, EP 0784072-A1).

### Plasticizers

The rubber compositions forming the rubber compound of the invention may comprise at least one plasticizer.

As is known to those skilled in the art of rubber compositions for pneumatic or non-pneumatic tyres, this plasticizer is preferably selected from hydrocarbon resins with a high glass transition temperature (Tg), low-Tg hydrocarbon resins, plasticizing oils and mixtures thereof. Preferably, the plasticizer is selected from hydrocarbon resins having a high Tg, plasticizing oils and mixtures thereof.

As is known, the plasticizers in the rubber compositions make it possible to modify the viscosity of a rubber composition, to adjust the glass transition temperature of the rubber composition with respect to its optimum use.

A high-Tg hydrocarbon resin is by definition a solid at ambient temperature and pressure (20° C., 1 atm), while a plasticizing oil is liquid at ambient temperature and pressure and a low-Tg hydrocarbon resin is viscous at ambient temperature and pressure.

Hydrocarbon resins, also known as hydrocarbon plasticizing resins, are polymers well known to those skilled in the art, essentially based on carbon and hydrogen but which can comprise other types of atoms, for example oxygen, which can be used in particular as plasticizing agents. They are by nature at least partially miscible (i.e. compatible) at the contents used with the rubber compositions for which they are intended, so as to act as true diluents. They have been described, for example, in the book entitled “Hydrocarbon Resins” by R. Mildenberg, M. Zander and G. Collin (New York, V C H, 1997, ISBN 3-527-28617-9), Chapter 5 of which is devoted to their applications, notably in the pneumatic tyre rubber field (5.5. “Rubber Tires and Mechanical Goods”). In a known manner, these hydrocarbon-based resins may also be termed thermoplastic resins in the sense that they soften when heated and can thus be moulded. The softening point of the hydrocarbon resins is measured according to Standard ISO 4625 (“Ring and Ball” method). The Tg is measured according to Standard ASTM D3418 (2008). The macrostructure (Mw, Mn and PDI) of the hydrocarbon resin is determined by size exclusion chromatography (SEC): solvent tetrahydrofuran; temperature 35° C.; concentration 1 g/l; flow rate 1 ml/min; solution filtered through a filter with a porosity of 0.45 μm before injection; Moore calibration with polystyrene standards; set of 3 Waters columns in series (Styragel HR4E, HR1 and HR0.5); detection by differential refractometer (Waters 2410) and its associated operating software (Waters Empower). The hydrocarbon-based resins may be aliphatic, aromatic or of the aliphatic/aromatic type, i.e. based on aliphatic and/or aromatic monomers. They may be natural or synthetic and may or may not be petroleum-based (if such is the case, they are also known as petroleum resins). High-Tg hydrocarbon-based resins are known to be thermoplastic hydrocarbon-based resins with a Tg above 20° C.

Preferably, the plasticizer can optionally comprise a hydrocarbon resin, which is a solid at ambient temperature and pressure, referred to as a high-Tg resin. Preferably, the high Tg plasticizing hydrocarbon resin exhibits at least any one of the following characteristics:
a Tg above 30° C.;
a number-average molecular weight (Mn) of between 300 and 2000 g/mol, more preferentially between 400 and 1500 g/mol;
a polydispersity index (PDI) of less than 3, more preferentially of less than 2 (as a reminder: PDI=Mw/Mn with Mw being the weight-average molecular mass).

More preferentially, this high-Tg plasticizing hydrocarbon resin exhibits all of the preferential characteristics above.

The plasticizer may optionally comprise a hydrocarbon resin which is viscous at 20° C., known as a “low-Tg” resin, that is to say which, by definition, has a Tg within a range extending from −40° C. to 20° C.

Preferably, the low-Tg plasticizing hydrocarbon resin exhibits at least any one of the following characteristics:
a Tg of between −40° C. and 0° C., more preferentially between −30° C. and 0° C. and more preferentially still between −20° C. and 0° C.;
a number-average molecular weight (Mn) of less than 800 g/mol, preferably of less than 600 g/mol and more preferentially of less than 400 g/mol;
a softening point within a range extending from 0° C. to 50° C., preferentially from 0° C. to 40° C., more preferentially from 10° C. to 40° C., preferably from 10° C. to 30° C.;
a polydispersity index (PDI) of less than 3, more preferentially of less than 2 (as a reminder: PDI=Mw/Mn with Mw being the weight-average molecular mass).

More preferentially, this low-Tg hydrocarbon resin exhibits all of the preferential characteristics above.

The plasticizer can also contain an extender oil (or plasticizing oil) which is liquid at 20° C., referred to as “low-Tg” plasticizer, that is to say which by definition has a Tg below −20° C., preferably below −40° C. Any extender oil, whether it is of aromatic or non-aromatic nature, known for its plasticizing properties with regard to elastomers, can be used. At ambient temperature (20° C.), these oils, which are more or less viscous, are liquids (that is to say, as a reminder, substances which have the ability to take on the shape of their container), as opposed, notably, to hydrocarbon resins having a high Tg, which are by nature solids at ambient temperature. Plasticizing oils selected from the group consisting of naphthenic oils (of high or low viscosity, notably hydrogenated or non-hydrogenated), paraffinic oils, MES (Medium Extracted Solvate) oils, TDAE (Treated Distillate Aromatic Extract) oils, RAE (Residual Aromatic Extract) oils, TRAE (Treated Residual Aromatic Extract) oils, SRAE (Safety Residual Aromatic Extract) oils, mineral oils, vegetable oils, ether plasticizers, ester plasticizers, phosphate plasticizers, sulfonate plasticizers, and mixtures of these compounds, are particularly suitable for use.

The high-Tg hydrocarbon resins, the low-Tg hydrocarbon resins, and the preferential plasticizing oils above are well known to those skilled in the art and commercially available.

### Other Additives

The rubber compositions forming the rubber compound in accordance with the invention can also comprise all or part of the usual additives and processing aids known to those skilled in the art and generally used in rubber compositions for pneumatic or non-pneumatic tyres, in particular for treads, such as, for example, fillers (reinforcing or non-reinforcing/other than those mentioned above), pigments, protective agents, such as antiozone waxes, chemical antiozonants or antioxidants, anti-fatigue agents or reinforcing resins (such as described, for example, in application WO 02/10269).

### Sulfur Vulcanization System

The rubber compound according to the invention comprises at least one sulfur vulcanization system, this vulcanization system comprising at least one vulcanization accelerator A selected from the group consisting of thiurams, dithiocarbamates, dithiophosphates, xanthates and mixtures thereof.

The sulfur may be in the form of molecular sulfur and/or sulfur donor. As an example of a sulfur donor, mention may in particular be made of polymeric sulfur or caprolactam disulfide.

Advantageously, the sulfur content in the rubber compound of the invention is within a range extending from 0.5 to 12 phr, more preferentially extending from 0.5 to 10 phr.

Generally, the vulcanization accelerators may be classified into two categories depending on whether they enable a more or less rapid initiation of the vulcanization. This initiation of the vulcanization may be represented by the “t0” value of the accelerator. Thus, vulcanization accelerators having a vulcanization initiation time “t0” of strictly less than 3.0 minutes, preferably less than or equal to 2.5 minutes, also called vulcanization ultra-accelerators, are distinguished from vulcanization accelerators having a vulcanization initiation time “t0” of greater than or equal to 3.0 minutes. The term “ultra-accelerator” is therefore known to denote vulcanization accelerators having a shorter “t0” than a conventional vulcanization accelerator, that is to say in this case a “t0” strictly less than 3.0 minutes.

The “t₀” value for a given accelerator should be measured in a given rubber composition at a given vulcanization temperature. In order to compare “slow” or “fast” accelerators according to their “t0” value, the reference composition used here is a composition comprising 100 phr of NR, 47 phr of carbon black N326, 0.9 phr of stearic acid, 7.5 phr of ZnO, 4.5 phr of sulfur, and the accelerator for which the “t0” is to be determined, at a molar content of 2.3 mmol per 100 parts by weight of elastomer. The method of measurement of the “t0” is in accordance with Standard DIN-53529, at 150° C. For the purpose of the present application, “to” means the to as defined and measured below.

For example, Table No. 1 below gives the “t0” of certain vulcanization accelerators, measured with the proposed measurement method.

TABLE 1

| | CBS⁽¹⁾ | TBzTD⁽²⁾ |
|---|---|---|
| molar mass (g/mol) | 264.41 | 544.42 |
| “t0” in min | 3.0 | 1.5 |

⁽¹⁾N-cyclohexyl-2-benzothiazolsulfenamide (CBS) sold by Quimica under the reference “Rubenamid-C”,
⁽²⁾Tetrabenzylthiuram disulfide (TBzTD) sold by Harwick under the reference “Ekaland TBZTD C”. This vulcanization accelerator is classified within the vulcanization ultra-accelerators.

The vulcanization (ultra-)accelerator A which can be used in the context of the mixtures of the present invention is selected from the group consisting of thiurams, dithiocarbamates, dithiophosphates, xanthates and mixtures thereof. Those skilled in the art will clearly understand that these accelerators of the type of thiurams, dithiocarbamates, dithiophosphates, xanthates and mixtures thereof are accelerators of the type of thiurams, dithiocarbamates, dithiophosphates, xanthates and mixtures thereof, and have a vulcanization initiation time, termed “t0”, of strictly less than 3.0 minutes, preferably less than or equal to 2.5 minutes.

Particularly advantageously, the vulcanization (ultra)-accelerator A can be selected from the group consisting of tetrabenzyl thiuram disulfide (TBzTD), tetramethyl thiuram monosulfide (TMTM), tetramethyl thiuram disulfide (TMTD), tetraethyl thiuram disulfide (TETD), tetraisobutyl thiuram disulfide (TiBTD), dipentamethylene thiuram tetrasulfide (DPTT), zinc dibutyl dithiocarbamate (ZDBC), zinc diethyl dithiocarbamate, zinc dimethyl dithiocarbamate, copper dimethyl dithiocarbamate, tellurium diethyl dithiocarbamate (TDEC), zinc diisononyl dithiocarbamate, zinc pentamethylene dithiocarbamate, zinc dibenzyldithiocarbamate (ZBEC), zinc isopropyl xanthate (ZIX), zinc butyl xanthate (ZBX), sodium ethyl xanthate (SEX), sodium isobutyl xanthate (SIBX), sodium isopropyl xanthate (SIPX), sodium n-butyl xanthate (SNBX), sodium amyl xanthate (SAX), potassium ethyl xanthate (PEX), potassium amyl xanthate (PAX), zinc 2-ethylhexylphosphorodithioate (ZDT/S), and mixtures of these compounds.

More preferentially, the vulcanization (ultra-)accelerator A may be selected from the group consisting of tetrabenzyl thiuram disulfide (TBzTD), tetramethyl thiuram monosulfide (TMTM), tetramethyl thiuram disulfide (TMTD), tetraethyl thiuram disulfide (TETD), tetraisobutyl thiuram disulfide (TiBTD), dipentamethylene thiuram tetrasulfide (DPTT), zinc dibutyl dithiocarbamate (ZDBC), zinc diethyl dithiocarbamate, zinc dimethyl dithiocarbamate, zinc diisononyl dithiocarbamate, zinc pentamethylene dithiocarbamate, zinc dibenzyldithiocarbamate (ZBEC), and mixtures of these compounds.

Even more preferentially, the vulcanization (ultra-)accelerator A may be selected from the group consisting of tetrabenzyl thiuram disulfide (TBzTD), tetramethyl thiuram disulfide (TMTD), tetraethyl thiuram disulfide (TETD), tetraisobutyl thiuram disulfide (TiBTD), zinc dibutyl dithiocarbamate (ZDBC), zinc dibenzyl dithiocarbamate (ZBEC), and mixtures of these compounds.

The content of vulcanization (ultra-)accelerator A in the rubber compound of the invention may preferably be within a range extending from 0.5 to 10 phr, preferably from 1.0 to 4.5 phr, even more preferentially extending from 1.0 to 3 phr.

Preferably, the ratio of the content of sulfur, expressed in phr, to the content of vulcanization (ultra-)accelerator A, expressed in phr, is within a range extending from 0.05 to 24, preferably from 0.16 to 10.

Various known secondary vulcanization accelerators or vulcanization activators, such as metal oxides (typically zinc oxide), derivatives of stearic acid (typically stearic acid) or equivalent compounds, or guanidine derivatives (in particular diphenylguanidine), well known to those skilled in the art may be added to this base vulcanization system, incorporated during the first non-productive phase and/or during the productive phase, as are described subsequently.

The vulcanization system which can be used for the rubber compound of the invention may comprise a content of metal oxide (preferably zinc oxide) of less than 12 phr. Preferably, the content of of metal oxide (preferably zinc oxide) is within a range extending from 0.5 to 10 phr, preferably from 1.0 to 7 phr. The content of stearic acid derivative (i.e. of stearic acid or of a salt of stearic acid, preferentially of stearic acid) is preferably less than 10 phr. Preferably, the content of stearic acid derivative (i.e. of stearic acid or of a salt of stearic acid, preferentially of stearic acid) is within a range extending from 0.5 to 10 phr and more preferentially from 1.0 to 5 phr.

In the present document, “stearic acid derivative” is understood to mean stearic acid or a salt of stearic acid, both being well known to those skilled in the art. By way of example of salt of stearic acid which can be used within the context of the present invention, mention may especially be made of zinc stearate or cadmium stearate.

Preferentially, in addition to the sulfur of the vulcanization (ultra-)accelerator A, the vulcanization system may comprise zinc oxide, the ratio of the zinc oxide content, expressed in phr, to the vulcanization (ultra-)accelerator A content, expressed in phr, is within a range extending from 0.05 to 20, more preferentially extending from 0.22 to 7.

Also disclosed in the present invention is a rubber compound according to the invention, in which the vulcanization system comprises sulfur in a content within a range extending from 0.5 to 10 phr, a vulcanization (ultra-)accelerator A as defined above, including the preferred forms thereof, in a content within a range extending from 1 to 4.5 phr, more preferentially from 1 to 3 phr, and zinc oxide, in a content, the ratio of the zinc oxide content, expressed in phr, to the vulcanization (ultra-)accelerator A content, expressed in phr, being within a range extending from 0.05 to 20, more preferentially extending from 0.22 to 7.

Advantageously, the rubber compound according to the invention does not comprise any vulcanization accelerator, referred to in the remainder of the description as vulcanization accelerator B, having a “t0” of greater than or equal to 3.0 minutes or comprising less than 0.5 phr, preferably comprising less than 0.1 phr, thereof.

Very preferentially, the rubber compound does not comprise any vulcanization accelerator B. The vulcanization accelerator B, that is to say having having a “t0” of greater than or equal to 3.0 minutes, may be for example selected from the group consisting of accelerators of thiazole type and also derivatives thereof, accelerators of sulfenamide type, thiourea accelerators and mixtures thereof. For example, the vulcanization accelerator having a “t0” of greater than or equal to 3.0 minutes may be selected from the group comprising or consisting of 2-mercaptobenzothiazole disulfide (MBTS), N-cyclohexyl-2-benzothiazolesulfenamide (CBS), N,N-dicyclohexyl-2-benzothiazolesulfenamide (DCBS), N-(tert-butyl)-2-benzothiazolesulfenamide (TBBS), N-(tert-butyl)-2-benzothiazolesulfenimide (TBSI), morpholine disulfide, N-morpholino-2-benzothiazolesulfenamide (MBS), dibutylthiourea (DBTU) and mixtures of these compounds.

According to this embodiment, the sulfur vulcanization system for the rubber compound of the invention comprises at least one vulcanization accelerator A selected from the group consisting of thiurams, dithiocarbamates, dithiophosphates, xanthates and mixtures thereof, more preferentially from the group consisting of thiurams, dithiocarbamates and mixtures thereof, and at least one vulcanization accelerator B in a content of less than or equal to 0.5 phr, more preferentially less than 0.1 phr; the vulcanization accelerator B being selected from the group consisting of thiazoles, sulfenamides, thioureas and mixtures thereof.

### Rubber Composition C1

The rubber compound according to the invention comprises at least one rubber composition, denoted C1, having a defined glass transition temperature denoted Tg1.

This rubber composition C1 comprises at least one elastomer E1 as defined above; it being understood that the elastomer E1 is of a different chemical nature from the diene elastomer E2. Preferably, the elastomer E1 is a diene elastomer, more preferentially still is a non-functionalized diene elastomer.

Even more preferentially, the elastomer E1 of the rubber composition C1 is selected from the group consisting of polybutadienes, butadiene/styrene copolymers, butadiene/isoprene copolymers, isoprene/styrene copolymers and butadiene/styrene/isoprene copolymers. Preferentially, the elastomer E1 of the rubber composition C1 is selected from the group consisting of polybutadienes and butadiene/styrene copolymers. More preferentially, the elastomer E1 of the rubber composition C1 is a styrene/butadiene copolymer.

Preferentially, this elastomer E1 is a non-functionalized diene elastomer. For the purposes of the present invention, “a non-functionalized diene elastomer” is understood to mean a diene elastomer, whether natural or synthetic, which does not bear a chemical function capable of interacting with a reinforcing filler. Preferentially, the non-functionalized diene elastomer may consist essentially of carbon and hydrogen atoms. It may comprise no heteroatoms or else heteroatoms in amounts which are impurities and which result from its method of synthesis.

Preferentially, the diene elastomer E1, preferably a styrene/butadiene copolymer, is non-functionalized and has a glass transition temperature TgE1 above or equal to −50° C. More preferentially, the glass transition temperature TgE1 is within a range extending from −50° C. to 0° C., more preferentially from −40° C. to 0° C., more preferentially from −30° C. to 0° C.

In one embodiment, the rubber composition C1 may also comprise at least one reinforcing filler. The reinforcing filler can be any type of reinforcing filler as described above. Preferentially, the reinforcing filler is selected from the group consisting of a carbon black, an inorganic reinforcing filler and mixtures thereof. More preferentially still, the reinforcing filler is selected from the group consisting of a carbon black, a silica and mixtures thereof. In this embodiment, the content of reinforcing filler in the composition C1 is less than the content of reinforcing filler in the composition C2.

The rubber composition C1 can also comprise at least one plasticizer as described above or any other additive described above.

### Rubber Composition C2

The rubber compound according to the invention comprises at least one rubber composition, denoted C2, having a defined glass transition temperature denoted Tg2.

This rubber composition C2 comprises at least one diene elastomer E2 which is an isoprene elastomer.

The term “isoprene elastomer” is understood, in a known manner, to mean an isoprene homopolymer or copolymer, in other words a diene elastomer selected from the group consisting of natural rubber (NR), synthetic polyisoprenes (IRs), the various isoprene copolymers, and the mixtures of these elastomers. Mention will in particular be made, among the isoprene copolymers, of isobutene/isoprene (butyl rubber-IIR), isoprene/styrene (SIR), isoprene/butadiene (BIR) or isoprene/butadiene/styrene (SBIR) copolymers.

The isoprene diene elastomer E2 is preferably natural rubber or a synthetic cis-1,4 polyisoprene. Of these synthetic polyisoprenes, use is preferably made of polyisoprenes that have a content (mol %) of cis-1,4 bonds greater than 90%, more preferentially still greater than 98%.

Advantageously, the glass transition temperature TgE2 of the elastomer E2, preferably diene elastomer which is in particular functionalized, is within a range extending from −110° C. to −23° C., preferably extending from −100° C. to −28° C., more preferentially extending from −95° C. to −30° C.

The rubber composition C2 further comprises at least one reinforcing filler. The reinforcing filler can be any type of reinforcing filler as described above. Preferentially, the reinforcing filler of the composition C2 predominantly comprises at least one inorganic reinforcing filler, more preferentially predominantly comprises at least one silica.

The rubber composition C2 can also comprise at least one plasticizer as described above or any other additive described above.

### Rubber Compound According to the Invention and its Manufacturing Process

As seen previously, the rubber compound in accordance with the invention has at least two glass temperatures Tg1 and Tg2 and results from the specific combination of a sulfur vulcanization system and of at least two rubber compositions C1 and C2 selected in such a way that:
the glass transition temperature Tg1 of composition C1 is above or equal to −50° C.,
the rubber compound satisfies the mathematical relationship Tg1-Tg2≥23° C.,
the rubber compound has a loss factor profile showing the evolution of tan δ as a function of temperature in ° C., the loss factor profile being measured over a temperature range extending from −80° C. to 60° C. at a frequency of 10 Hz and a constant stress of 0.7 MPa and exhibiting one or more peaks, this profile being such that all the tan δ (tan delta) peaks present at a temperature above the glass transition temperature Tg1 have a mid-height width of below or equal to 23° C.; and
the elastomer E1 is predominant in the rubber compound,
the elastomer E2 is an isoprene diene elastomer; and
the sulfur vulcanization system comprises at least one vulcanization accelerator A selected from the group consisting of thiurams, dithiocarbamates, dithiophosphates, xanthates and mixtures thereof.

Surprisingly, this specific combination of rubber compositions of which the vulcanization system comprises at least one vulcanization accelerator A selected from the group consisting of thiurams, dithiocarbamates, dithiophosphates, xanthates and mixtures thereof makes it possible to obtain a rubber compound with simultaneously improved hysteresis and good wet grip properties. Without being bound by theory, if the rubber compound exhibits a glass transition temperature difference of below 23° C., then the hysteresis properties are degraded and the rubber compound does not exhibit good rolling resistance. If the rubber compound has a loss factor profile exhibiting the change in tan δ as a function of the temperature in ° C., the loss factor profile being measured over a temperature range extending from −80° C. to 60° C. at a frequency of 10 Hz and a constant stress of 0.7 MPa and exhibiting one or more peaks, this profile being such that all the tan δ (tan delta) peaks present at a temperature above the glass transition temperature Tg1 have a width at half height above 23° C., then the rubber compound has a poor coefficient of dynamic friction, and therefore degraded wet grip properties. The presence of the specific vulcanization system as mentioned above makes it possible to improve these properties when the elastomer E2 is an isoprene diene elastomer, preferably natural rubber.

Preferentially, the rubber compound satisfies the mathematical relationship Tg1-Tg2≥25° C., preferably Tg1-Tg2≥28° C.

Advantageously, the rubber compound satisfies the mathematical relationship 25° C.≤Tg1-Tg2≤40° C.

Preferentially, the glass transition temperature Tg1 of the rubber composition C1 is above or equal to −48° C., preferably above or equal to −40° C.

Preferentially, the glass transition temperature Tg1 of the rubber composition C1 is within a range extending from −48° C. to −15° C., preferably within a range extending from −40° C. to −15° C.

Preferentially, the glass transition temperature Tg2 of the rubber composition C2 is below or equal to −43° C., preferably below or equal to −50° C.

Preferentially, the glass transition temperature Tg2 of composition C2 is within a range extending from −90° C. to −43° C., preferably extending from −85° C. to −50° C.

Preferentially, the rubber compound according to the invention is based on at least one sulfur vulcanization system and at least one rubber composition C1 with a glass transition temperature Tg1 and comprising a non-functionalized diene elastomer E1, even more preferentially a styrene/butadiene copolymer, and the glass transition temperature Tg1 being within a range extending from −48° C. to −15° C., and a rubber composition C2 with a glass transition temperature Tg2 and comprising an isoprene diene elastomer E2, preferably natural rubber, and the glass transition temperature Tg2 being within a range extending from −90° C. to −43° C.; the rubber compound satisfies the mathematical relationship Tg1-Tg2≤28° C., the rubber compound having a loss factor profile showing the change in tan δ as a function of temperature in ° C., the loss factor profile being measured over a temperature range extending from −80° C. to 60° C. at a frequency of 10 Hz and a constant stress of 0.7 MPa and exhibiting one or more peaks, this profile being such that all tan δ peaks present at a temperature above the glass transition temperature Tg1 have a width at half height of below or equal to 23° C., the elastomer E1 being predominant in the rubber compound and the sulfur vulcanization system comprising at least one vulcanization accelerator A selected from the group consisting of thiurams, dithiocarbamates, dithiophosphates, xanthates and mixtures thereof, more preferentially at least one vulcanization accelerator A selected from the group consisting of thiurams, dithiocarbamates and mixtures thereof.

Preferentially, the rubber compound according to the invention is based on at least one sulfur vulcanization system and at least one rubber composition C1 with a glass transition temperature Tg1 and comprising a non-functionalized diene elastomer E1, even more preferentially a styrene/butadiene copolymer, and the glass transition temperature Tg1 being within a range extending from −40° C. to −15° C., and a rubber composition C2 with a glass transition temperature Tg2 and comprising an isoprene diene elastomer E2, preferably natural rubber, and the glass transition temperature Tg2 being within a range extending from −85° C. to −50° C.; the rubber compound satisfies the mathematical relationship Tg1-Tg2≥28° C., the rubber compound having a loss factor profile showing the change in tan δ as a function of temperature in ° C., the loss factor profile being measured over a temperature range extending from −80° C. to 60° C. at a frequency of 10 Hz and a constant stress of 0.7 MPa and exhibiting one or more peaks, this profile being such that all tan δ peaks present at a temperature above the glass transition temperature Tg1 have a width at half height of below or equal to 23° C., the elastomer E1 being predominant in the rubber compound and the sulfur vulcanization system comprising at least one vulcanization accelerator A selected from the group consisting of thiurams, dithiocarbamates, dithiophosphates, xanthates and mixtures thereof, more preferentially at least one vulcanization accelerator A selected from the group consisting of thiurams, dithiocarbamates and mixtures thereof.

Preferentially, the content of the elastomer E1, preferably diene elastomer, in particular which is non-functionalized, even more preferentially a styrene/butadiene copolymer, in the rubber compound of the invention is within a range extending from 50 phr to 70 phr, preferably from 55 phr to 70 phr, more preferentially from 55 phr to 65 phr.

Preferentially, the content of the isoprene diene elastomer E2, preferably natural rubber, in the rubber compound of the invention is below or equal to 40 phr, more preferentially is within a range extending from 30 phr to 50 phr, preferably from 30 phr to 45 phr, more preferentially from 35 phr to 45 phr.

Advantageously, the content of the elastomer E1, preferably diene elastomer, in particular which is non-functionalized, even more preferentially a styrene/butadiene copolymer, in the rubber compound of the invention is within a range extending from 50 phr to 70 phr, and the content of the isoprene diene elastomer E2, preferably natural rubber, in the rubber compound of the invention is within a range extending from 30 phr to 50 phr. Advantageously, the content of the elastomer E1, preferably diene elastomer, which is in particular non-functionalized, even more preferentially a styrene/butadiene copolymer, in the rubber composition of the invention is within a range extending from 55 phr to 70 phr, and the content of the isoprene diene elastomer E2, preferably natural rubber, in the rubber compound of the invention is within a range extending from 30 phr to 45 phr.

Preferably, the content of reinforcing filler in the rubber compound of the invention is within a range extending from 20 to 100 phr, more preferentially from 30 to 90 phr, and even more preferentially from 40 to 90 phr, the optimum being, in a known way, different depending on the specific applications targeted.

When the reinforcing filler is a reinforcing inorganic filler such as a silica for example, it may be advantageous to use a coupling agent. Preferentially, the content of coupling agent in the rubber compound of the invention is advantageously below or equal to 20 phr, it being understood that it is generally desirable to use as little as possible thereof. Typically, the content of coupling agent represents from 0.5% to 15% by weight, with respect to the amount of reinforcing inorganic filler. Its content is preferentially within a range extending from 0.5 to 20 phr. This content is easily adjusted by those skilled in the art according to the content of reinforcing inorganic filler used in the composition of the invention.

According to a preferred embodiment, the reinforcing filler is predominantly an inorganic reinforcing filler (preferably silica) in the rubber compound according to the invention, that is to say that the reinforcing filler comprises more than 50% (>50%) by weight of an inorganic reinforcing filler such as silica relative to the total weight of the reinforcing filler in the rubber compound. Optionally according to this embodiment, the reinforcing filler can also comprise carbon black. According to this option, the carbon black is used in a content of below or equal to 20 phr in the rubber compound, more preferentially below or equal to 10 phr (for example the carbon black content may be within a range extending from 0.5 to 20 phr, in particular extending from 1 to 10 phr in the rubber compound). Within the ranges indicated, the colouring (black pigmentation agent) and anti-UV properties of carbon blacks are exploited, without otherwise penalizing the typical performance provided by the reinforcing inorganic filler.

### Process for Manufacturing the Rubber Compound

The rubber compound of the invention can be obtained by the customary processes for manufacturing rubber compounds, such as dry mixing of the various ingredients.

According to one embodiment, the rubber compound in accordance with the invention is manufactured in appropriate mixers using two successive preparation phases well known to those skilled in the art:
a first phase of thermomechanical working or kneading (“non-productive” phase), which can be carried out in a single thermomechanical step during which, in the following sequential order, the isoprene diene elastomer E2 of the rubber composition with a glass transition temperature Tg2, the reinforcing filler and optionally the coupling agent for the reinforcing filler are introduced into an appropriate mixer, such as a standard internal mixer (for example of “Banbury” type). After thermomechanical kneading, during which these ingredients are maintained at a temperature within a range extending from 140° C. to 200° C. for one to two minutes, the elastomer E1 of the rubber composition with a glass transition temperature Tg1, and also all the necessary constituents, with the exception of the vulcanization system, are introduced into the internal mixer. These ingredients undergo thermomechanical kneading for 2 to 10 minutes up to a maximum temperature within a range extending from 110° C. to 200° C., preferably extending from 130° C. to 185° C. (and referred to as the “dropping temperature”);
a second phase of mechanical working (“productive” phase) is carried out in an external mixer, such as an open mill, after cooling the mixture obtained during the non-productive first phase down to a lower temperature, typically below 120° C., for example in a range extending from 40° C. to 100° C. The vulcanization system comprising at least one vulcanization accelerator A selected from the group consisting of thiurams, dithiocarbamates, dithiophosphates, xanthates and mixtures thereof, more preferentially at least one vulcanization accelerator A selected from the group consisting of thiurams, dithiocarbamates and mixtures thereof, is then incorporated, while mixing for 5 to 15 min in order to obtain the rubber compound of the invention.

According to another preferred embodiment of the invention, the rubber compound of the invention is prepared in the form of two rubber compositions, then the rubber compositions are combined so as to obtain the rubber compound according to the invention.

More specifically, according to this embodiment, the rubber compound as defined above and its preferential embodiments can be obtained according to the manufacturing process comprising the following steps:
preparing the rubber composition C1 in an internal mixer by introducing the elastomer E1 of the rubber composition C1 and, where appropriate, the other ingredients such as a plasticizer and carrying out thermomechanical working up to a maximum temperature of 200° C. in order to obtain the rubber composition C1;
preparing the rubber composition C2 in an internal mixer by introducing the isoprene diene elastomer E2 of the rubber composition C2, the reinforcing filler, where appropriate the other ingredients such as a plasticizer or a coupling agent for the reinforcing filler, and carrying out thermomechanical working up to a maximum temperature of 200° C. in order to obtain the rubber composition C2;
introducing the rubber compositions C1 and C2 obtained in the preceding steps into an internal mixer and carrying out thermomechanical working up to a maximum temperature of 180° C. in order to obtain a combination of compositions;
recovering the combination of compositions from the preceding step and cooling it to a temperature below or equal to 110° C.;
incorporating into the cooled combination of compositions the vulcanization system comprising at least one vulcanization accelerator A selected from the group consisting of thiurams, dithiocarbamates, dithiophosphates, xanthates and mixtures thereof, more preferentially at least one vulcanization accelerator A selected from the group consisting of thiurams, dithiocarbamates and mixtures thereof, and kneading the whole mix to a maximum temperature of below 110° C., preferentially below 80° C., and recovering the rubber compound.

More specifically, the first rubber composition, referred to as composition C1, is prepared by mixing, in a suitable mixer such as a standard internal mixer (for example of “Banbury” type), the elastomer E1 and the other optional constituents of the composition C1 such as plasticizer(s), antiozonants, etc., with the exception of the vulcanization system. Thermomechanical working is carried out for 2 to 10 minutes up to a maximum temperature within a range extending from 110° C. to 200° C., preferably extending from 130° C. to 185° C. (and referred to as the “dropping temperature”). The rubber composition C1 is thus recovered.

Next, the second rubber composition, referred to as composition C2, is prepared by mixing, in a suitable mixer such as a standard internal mixer (for example of “Banbury” type), the isoprene diene elastomer E2, the reinforcing filler and the other optional constituents such as plasticizer(s) and the coupling agent for the reinforcing filler, antiozonants, etc., with the exception of the vulcanization system. Thermomechanical working is carried out for a time of 2 to 10 minutes up to a maximum temperature within a range extending from 140° C. to 200° C., preferably extending from 140° C. to 185° C. (and referred to as the “dropping temperature”). The rubber composition C2 is thus recovered.

The two rubber compositions C1 and C2 from the preceding steps are introduced into a standard internal mixer (for example of “Banbury” type) and thermomechanical working is carried out for 2 to 10 minutes up to a maximum temperature within a range extending from 110° C. to 180° C., preferably extending from 130° C. to 180° C. (and referred to as the “dropping temperature”).

The compound of the previous step is then cooled down on an external mixer, such as an open mill, to a temperature of below or equal to 110° C. The vulcanization system comprising at least one vulcanization accelerator A selected from the group consisting of thiurams, dithiocarbamates, dithiophosphates, xanthates and mixtures thereof, more preferentially at least one vulcanization accelerator A selected from the group consisting of thiurams, dithiocarbamates and mixtures thereof, is then incorporated, by mixing for 5 to 15 min and the rubber compound according to the invention is recovered.

Irrespective of the method of preparing the rubber compound, the final rubber compound thus obtained is subsequently calendered, for example in the form of a sheet or slab, notably for laboratory characterization, or else extruded in the form of a rubber semi-finished product (or profiled element) which can be used, for example, as a tread in a pneumatic or non-pneumatic tyre, in particular for a passenger vehicle.

The rubber compound may be either in the uncured state (before vulcanization) or in the cured state (after vulcanization), and may be a semi-finished product which can be used in a pneumatic or non-pneumatic tyre.

The vulcanization of the rubber compound can be carried out in a manner known to those skilled in the art, for example at a temperature within a range extending from 130° C. to 200° C., under pressure.

### Other Subjects of the Invention

Another subject of the present invention is a tread of a pneumatic or non-pneumatic tyre comprising at least one rubber compound defined above. The rubber compound according to the invention can constitute the whole tread or else part of the tread.

Another subject of the present invention relates to a pneumatic tyre or non-pneumatic tyre comprising at least one rubber compound defined above or comprising at least one tread defined above.

The term “pneumatic tyre” means a tyre designed to form a cavity by engaging with a support element, for example a rim, this cavity being capable of being pressurized to a pressure greater than atmospheric pressure. In contrast, a “non-pneumatic tyre” is not able to be pressurized. Thus, a non-pneumatic tyre is a toric body made up of at least one polymer material, intended to perform the function of a tyre but without being subjected to an inflation pressure. A non-pneumatic tyre may be solid or hollow. A hollow non-pneumatic tyre may contain air, but at atmospheric pressure, i.e. it has no pneumatic stiffness provided by an inflation gas at a pressure greater than atmospheric pressure.

The pneumatic tyres according to the invention are intended to be fitted notably on vehicles of all types such as passenger vehicles, two-wheeled vehicles, heavy goods vehicles, agricultural vehicles, civil engineering vehicles or aircraft or, more generally, on any rolling device. Non-pneumatic tyres are intended notably to be fitted on passenger vehicles or two-wheeled vehicles. Preferably, the pneumatic tyres according to the invention are intended to be fitted to passenger vehicles.

Preferentially, the pneumatic tyre or the non-pneumatic tyre comprises at least one tread comprising at least one rubber compound defined above.

### Measurement Methods

### Determination of the Glass Transition Temperature of the Elastomers

The glass transition temperatures (Tg) of the elastomers, before their use, are determined using a differential scanning calorimeter according to Standard ASTM D3418:2008.

### Determination of the Glass Transition Temperature of the Rubber Compound

The glass transition temperature of the rubber compound is measured according to Standard NF EN ISO 11357-2:05-2014 using a Mettler Toledo DSC3+ machine and 40 μl aluminium crucibles.

The scanning measurements are carried out as follows under helium at a flow rate of 40 ml/min:
Sample brought from +25° C. to −150° C. with a ramp of 50° C./min;
Isotherm at −150° C. for 5 min;
Heating from −150° C. to +200° C. with a ramp of 20° C./min;
Isotherm at +200° C. for 5 min;
Cooling from +200° C. to −150° C. with a ramp of 20° C./min;
Isotherm at −150° C. for 5 min;
Heating from −150° C. to +200° C. with a ramp of 20° C./min.

### Determination of the μₘₐₓ Coefficient

The measurements of coefficient of dynamic friction were carried out according to a method identical to that described by L. Busse, A. Le Gal and M. Kuppel (Modelling of Dry and Wet Friction of Silica Filled Elastomers on Self-Affine Road Surfaces, Elastomer Friction, 2010, 51, p. 8). The test specimens were produced by moulding, then vulcanization of a square rubbery support (50 mm×50 mm) having a thickness of 6 mm. After closing the mould, the latter is placed in a press with heated platens at the temperature of 150° C., and for the time necessary for the vulcanization of the material (typically several tens of minutes), at a pressure of 16 bar. The ground used to carry out these measurements is a core withdrawn from a real road surface made of bituminous concrete of BBTM [very thin bituminous concrete] type (Standard NF P 98-137). In order to prevent the phenomena of dewetting and the appearance of secondary grip forces between the ground and the material, the ground+test specimen system is immersed in a 5% aqueous solution of a surfactant (Sinnozon—CAS number: 25155-30-0). The temperature of the aqueous solution is regulated using a thermostatically controlled bath. The test specimen is subjected to a sliding movement in translation parallel to the plane of the ground. The sliding velocity SV is set at 1.2 m/s. The normal stress applied σₙ is 400 kPa (i.e. 4 bar). These conditions are described below by “wet ground conditions”. The tangential stress σₜ, opposed to the movement of the test specimen over the ground, is measured continuously. The ratio of the tangential stress σₜ to the normal stress σₙ gives the coefficient of dynamic friction μ. The coefficient of dynamic friction values are measured during a temperature sweep of the aqueous solution, ranging from 3° C. to 44° C., are obtained in steady state after stabilization of the value of the tangential stress σₜ.

In the examples, the maximum value of the coefficient of dynamic friction (denoted μₘₐₓ) measured during this sweep is indicated.

Unless otherwise indicated, the results are given in base 100. The arbitrary value 100 being assigned to the comparative compound in order to calculate and then compare the maximum coefficient of dynamic friction of the various samples tested. The value in base 100 for the test sample is calculated according to the operation: (μₘₐₓvalue of the sample to be tested/value of the μₘₐₓ comparative mixture)×100. In this way, a result less than 100 will indicate a decrease in the μₘₐₓ coefficient and therefore a drop in the wet grip performance. Conversely, a result greater than 100 will indicate an increase in the μₘₐₓ coefficient and therefore an increase in the wet grip performance.

Measurement of the Dynamic Properties after Curing.

The dynamic properties tan (δ) are measured on a viscosity analyser (Metravib V A4000), according to Standard ASTM D 5992-96. The response of a sample of the vulcanized compound (2 cylindrical test specimens with a thickness of 2 mm and with a cross section of 78.5 mm²), subjected to a simple alternating sinusoidal shear stress, at a frequency of 10 Hz, and at a temperature of 23° C., is recorded. A peak-to-peak strain amplitude sweep is carried out from 1% to 100% (forward cycle) and then from 100% to 1% (return cycle). The results made use of are the loss factor (tan δ). For the return cycle, the maximum value of tan δ observed at 23° C. (tan δmax), denoted tan δ_{max at 23° C.}, is indicated.

For tan δ_{max at 23° C.}, the results are expressed as base 100 performance, that is to say that the value 100 is arbitrarily assigned to the comparative compound, in order to calculate and subsequently compare the tan δ_{max at 23° C.} of the various compounds tested. The value in base 100 is calculated according to the operation: (value of tan δ_{max at 23° C.} of the comparative compound/value of tan δ_{max at 23° C.} of the sample)*100. In this way, a lower value represents a decrease in hysteresis properties while a higher value represents an improvement in the hysteresis properties, thus an improvement in rolling resistance.

It is recalled, in a manner well known to those skilled in the art, that the value of tan δ at 0° C. representative of the potential wet grip. For this purpose, the same sample is also subjected to a simple alternating sinusoidal shear stress, at the frequency of 10 Hz, during a temperature sweep of −80° C. to +100° C., under a fixed stress of 0.7 MPa. The tan δ value at 0° C. (tan δ_{at 0° C.}) is recorded. The higher tan δ_{at ° C.}, the better the grip. The results are expressed as base 100 performance, that is to say that the value 100 is arbitrarily assigned to the comparative compound, in order to calculate and then compare the tan δ_{at 0° C.} of the various compounds tested. The value in base 100 is calculated according to the operation: (value of tan δ_{at 0° C.} of the comparative compound/value of tan δ_{at 0° C.} of the sample)*100.

### Measurement of the Profile of the Loss Factor Measured According to ASTM D 5992-96

The response of a test specimen consisting of two cylindrical pellets each 2 mm thick, 78.5 mm² in cross section and 1 cm in diameter is recorded. The test specimen is subjected to a simple alternating sinusoidal shear stress, at a frequency of 10 Hz, during a temperature sweep from −80° C. to +100° C. with a ramp of +1.5° C./min, under a constant stress of 0.7 MPa. The data is acquired at a frequency of 0.12 Hz which can be adapted to obtain the desired precision.

For the tan δ peaks present at a temperature above the glass transition temperature Tg1, the peak width at half height of each of these peaks is then determined.

This width at half height is defined as follows: let a given maximum be at a temperature TO and have an associated value of tan δ Y. All of the temperatures associated with values of tan δ equal to Y/2 are then recorded. Among these values, the peak width at half height then corresponds to the difference in ° C. between the two closest temperatures flanking TO the temperature of the maximum.

### EXAMPLES

### 1—Ingredients:

The ingredients used in the examples are the following:

Elastomer (1A): Non-functionalized styrene/butadiene copolymer having a Tg of −28° C. measured according to Standard ASTM D3418:2008, a styrene content of 41% by weight relative to the total weight of the copolymer, a vinyl-1,2 butadiene content of 14% by weight relative to the total weight of the copolymer, a trans-1,4 butadiene content of 27% by weight relative to the total weight of the copolymer.

Elastomer (1B): Styrene/butadiene copolymer bearing an aminoalkoxysilane function in the middle of the chain and having a Tg of −65° C. measured according to Standard ASTM D3418:2008, a styrene content of 16% by weight relative to the total weight of the copolymer, a vinyl-1,2 butadiene content of 20% by weight relative to the total weight of the copolymer, a trans-1,4 butadiene content of 39% by weight relative to the total weight of the copolymer.

Elastomer (1C): Natural rubber having a Tg of −70° C.

Silica (2): Zeosil 1165MP silica sold by Solvay.

Silane (3): Bis[3-(triethoxysilyl) propyl] tetrasulfide (TESPT) silane, sold by Evonik under the reference Si69;

DPG (4): Diphenylguanidine, Perkacit DPG from Flexsys.

Plasticizer (5): DCPD resin having a softening point of 100° C., a glass transition temperature of 51° C. sold under the reference PR-383 by Exxon Mobil.

ZnO (6): Zinc oxide (industrial grade), sold by Umicore.

Stearic acid (7): Pristerene 4031 stearin sold by Uniqema.

Anti-ozone wax (8): Varazon 4959 antiozone wax from Sasol Wax

Antioxidant (9): N-(1,3-dimethylbutyl)-N-phenyl-para-phenylenediamine sold by Flexsys under the reference Santoflex 6-PPD.

### 2. Test 1:

The purpose of this test is to show the improvement of the rubber properties of the compounds according to the invention (rubber compound MI1 and MI2) compared to control rubber compounds (rubber compound MT1 to MT4) as a function of the sulfur vulcanization system and the formulation of the compounds.

The comparative rubber compound MT1 is a complex rubber compound based on two compositions and comprising a sulfur vulcanization system with a conventional vulcanization accelerator.

The comparative rubber compound MT2 differs from the rubber compound MT1 by its sulfur vulcanization system that comprises a vulcanization ultra-accelerator instead of the conventional accelerator.

The comparative rubber compound MT3 differs from the rubber compound MT1 by the nature of the elastomer used in the composition C2 with Tg2.

The comparative rubber compound MT4 differs from the rubber compound MT3 by the nature of the vulcanization accelerator used.

The rubber compound according to the invention MI1 differs from the comparative compound MT2 by the nature of the elastomer used in the composition C2 with Tg2.

The rubber compound according to the invention MI2 differs from the rubber compound according to the invention MI1 by the use of a vulcanization ultra-accelerator of different chemical nature.

The formulation of the comparative compounds MT1 to MT4 and those of the invention MI1 and MI2 are presented in Table No. 2 and No. 3; the proportions are expressed in phr, that is to say in part by weight per 100 parts by weight of the elastomers of the compound.

TABLE 2

| | MT1 | MT2 |
|---|---|---|
| Elastomer (1A) | 60.0 | 60.0 |
| Elastomer (1B) | 40.0 | 40.0 |
| Silica (3) | 55.0 | 55.0 |
| Silane (4) | 5.5 | 5.5 |
| DPG (5) | 1.2 | 1.2 |
| Plasticizer (6) | 18.4 | 18.4 |
| ZnO (9) | 5.0 | 5.0 |
| Stearic acid (10) | 2.0 | 2.0 |
| Antiozone wax (7) | 2.0 | 2.0 |
| Antioxidant (8) | 1.0 | 1.0 |
| Sulfur | 0.5 | 0.5 |
| CBS | 2.0 | (—) |
| TBzTD | (—) | 5.0 |

TABLE 3

| | MT3 | MT4 | MI1 | MI2 |
|---|---|---|---|---|
| Elastomer (1A) | 60.0 | 60.0 | 60.0 | 60.0 |
| Diene elastomer (1C) | 40.0 | 40.0 | 40.0 | 40.0 |
| Silica (2) | 55.0 | 55.0 | 55.0 | 55.0 |
| Silane (3) | 5.5 | 5.5 | 5.5 | 5.5 |
| DPG (4) | 1.2 | 1.2 | 1.2 | 1.2 |
| Plasticizer (5) | 18.4 | 18.4 | 18.4 | 18.4 |
| ZnO (6) | 5.0 | 5.0 | 5.0 | 5.0 |
| Stearic acid (7) | 2.0 | 2.0 | 2.0 | 2.0 |
| Antiozone wax (8) | 2.0 | 2.0 | 2.0 | 2.0 |
| Antioxidant (9) | 1.0 | 1.0 | 1.0 | 1.0 |
| Sulfur | 0.5 | 0.5 | 0.5 | 0.5 |
| CBS | 2.0 | (—) | (—) | (—) |
| MBTS | (—) | 2.0 | (—) | (—) |
| ZBEC | (—) | (—) | (—) | 2.0 |
| TBzTD | (—) | (—) | 2.0 | (—) |

The comparative compound MT1 is obtained as follows:

Etape A: All the ingredients from Table 4 are introduced, in one or more stages, into a 414 cm³ Polylab internal mixer, filled to 70% by volume and the initial vessel temperature of which is 90° C. Thermomechanical working is carried out for 6 minutes until a maximum dropping temperature of 165° C. is reached. The composition thus obtained, referred to as composition C1, is recovered.

Step B: All the ingredients from Table 5 are introduced, in one or more stages, into another 414 cm³ Polylab internal mixer, filled to 70% by volume and the initial vessel temperature of which is 90° C. Thermomechanical working is carried out for 6 minutes until a maximum dropping temperature of 165° C. is reached. The composition thus obtained, referred to as composition C2, is recovered.

Step C: The composition C1 obtained previously and the preceding composition C2 are then introduced into a 414 cm³ Polylab internal mixer, filled to 70% by volume and thermomechanical working is carried out for 5 minutes until a maximum dropping temperature of 150° C. is reached.

Step D: The mixture from the previous step is then introduced into an external mixer, such as an open mill, so as to cool this mixture to a temperature of 40° C. The vulcanization system (0.5 phr of sulfur and 2.0 phr of N-cyclohexyl-2-benzothiazoyl sulfenamide (CBS) sold by Quimica under the reference Rubenamid-C is then incorporated and mixed for 20 min. The mixture thus obtained is then calendered in the form of slabs in order to carry out measurements of its physical or mechanical properties. Unless otherwise indicated, the rubber properties of the rubber compound are measured after curing at 170° C. for 20 min.

TABLE 4
Composition 1

| | |
|---|---|
| Elastomer (1A) | 60.0 |
| Silica (2) | 15.3 |
| Silane (3) | 2.2 |
| DPG (4) | 0.6 |
| Plasticizer (5) | 11.0 |
| ZnO (6) | 2.5 |
| Stearic acid (7) | 1.00 |
| Antiozone wax (8) | 1.0 |
| Antioxidant (9) | 0.5 |

TABLE 5
Composition 2

| | |
|---|---|
| Elastomer (1B) | 40.0 |
| Silica (2) | 39.7 |
| Silane (3) | 3.3 |
| DPG (4) | 0.6 |
| Plasticizer (5) | 7.4 |
| ZnO (6) | 2.5 |
| Stearic acid (7) | 1.0 |
| Antiozone wax (8) | 1.0 |
| Antioxidant (9) | 0.5 |

The compound MT2 is obtained by reproducing steps A to C of the process described for the comparative compound MT1 above with the compositions C1 and C2 of the respective Tables No. 4 and No. 5. Step D described above is also reproduced with the exception that the vulcanization system of the compound MT1 (0.5 phr of sulfur and 2.0 phr of N-cyclohexyl-2-benzothiazolesulfenamide (CBS) sold by Quimica under the reference Rubenamid-C is replaced with the following vulcanization system: 0.5 phr of sulfur and 2.0 phr of tetrabenzylthiuram disulfide (TBzTD) sold by Harwick under the reference Ekaland TBZTD C.

The comparative compound MT3 is obtained by reproducing steps A to C of the process described for the comparative compound MT1 with the compositions C1 and C3 of the respective Tables No. 4 and No. 6. Step D described above is also reproduced with the vulcanization system of the compound MT1 (i.e. 0.5 phr of sulfur and 2.0 phr of N-cyclohexyl-2-benzothiazolesulfenamide (CBS) sold by Quimica under the reference “Rubenamid-C”.

TABLE 6
Composition 3

| | |
|---|---|
| Elastomer (1C) | 40.0 |
| Silica (3) | 39.7 |
| Silane (4) | 3.3 |
| DPG (5) | 0.6 |
| Plasticizer (6) | 7.4 |
| Antiozone wax (7) | 1.0 |
| Antioxidant (8) | 0.5 |
| ZnO (9) | 2.5 |
| Stearic acid (10) | 1.0 |

The compound MT4 is obtained by reproducing steps A to C of the process described for the comparative compound MT1 above with the compositions C1 and C3 of the respective Tables No. 4 and No. 6. Step D described above is also reproduced with the exception that the vulcanization system of the compound MT1 (0.5 phr of sulfur and 2.0 phr of N-cyclohexyl-2-benzothiazolesulfenamide (CBS) sold by Quimica under the reference Rubenamid-C is replaced with the following vulcanization system: 0.5 phr of sulfur and 2.0 phr of 2-mercaptobenzothiazole disulfide (MBTS) sold by Quimica under the reference Rubator MBTS.

The compound MI1 according to the invention is obtained by reproducing steps A to C of the process described for the comparative compound MT1 above with the compositions C1 and C3 of the respective Tables No. 4 and No. 6. Step D described above is also reproduced with the exception that the vulcanization system of the compound MT1 (0.5 phr of sulfur and 2.0 phr of N-cyclohexyl-2-benzothiazolesulfenamide (CBS) sold by Quimica under the reference Rubenamid-C is replaced with the following vulcanization system: 0.5 phr of sulfur and 2.0 phr of tetrabenzylthiuram disulfide (TBzTD) sold by Harwick under the reference Ekaland TBZTD C.

The compound MI2 according to the invention is obtained by reproducing steps A to C of the process described for the comparative compound MT1 above with the compositions C1 and C3 of the respective Tables No. 4 and No. 6. Step D described above is also reproduced with the exception that the vulcanization system of the compound MT1 (0.5 phr of sulfur and 2.0 phr of N-cyclohexyl-2-benzothiazolesulfenamide (CBS) sold by Quimica under the reference Rubenamid-C is replaced with the following vulcanization system: 0.5 phr of sulfur and 2.0 phr of zinc dibenzyldithiocabamate (ZBEC) sold by Performance Additives under the reference Perkacit ZBEC C.

The rubber properties of the compounds MT1 to MT4 and MI1 and MI2, measured after curing, are presented in Tables No. 7 and No. 8.

TABLE 7

| | | MT1 | | MT2 | |
|---|---|---|---|---|---|
| Glass transition | Tg1 | −19° | C. | −18° | C. |
| temperature of the | Tg2 | −49° | C. | −47° | C. |
| compound (measured | | | | | |
| in ° C.) | | | | | |
| Loss factor profile | Peak width at | 17.3° | C. | 16.6° | C. |
| | half height | | | | |

| | | |
|---|---|---|
| Tan δ_{max at 23° C.} (base 100) | 100 | 100 |
| Tan δ_{at 0° C.} (base 100) | 100 | 94 |

TABLE 8

| | | MT3 | | MT4 | | MI1 | | MI2 | |
|---|---|---|---|---|---|---|---|---|---|
| Glass transition | Tg1 | −18° | C. | −17° | C. | −17° | C. | −18° | C. |
| temperature of the | Tg2 | −55° | C. | −55° | C. | −55° | C. | −55° | C. |
| compound (measured | | | | | | | | | |
| in ° C.) | | | | | | | | | |
| Loss factor profile | Peak width at | 23.0° | C. | 22.9° | C. | 22.6° | C. | 21.8° | C. |
| | half height | | | | | | | | |

| | | | | |
|---|---|---|---|---|
| Tan δ_{max at 23° C.} (base 100) | 100 | 94 | 107 | 107 |
| Tan δ_{at 0° C.} (base 100) | 100 | 61 | 113 | 168 |

When comparing the comparative compound MT1 and the comparative compound MT2, it is found that the use of a vulcanization ultra-accelerator of the thiuram family instead of a usual vulcanization accelerator of the sulfenamide family does not lead to improvements in the wet grip (Tan δ_{at 0° C.}) and rolling resistance (Tan δ_{max at 23° C.}) properties.

Surprisingly, this effect is not observed for the compound according to the invention (comparison of the compound MI1 according to the invention with the comparative compound MT3). Contrary to what has been observed for the comparative compounds MT1 and MT2, the use of this same vulcanization ultra-accelerator in a rubber compound of which the phase of lower Tg comprises an isoprene elastomer and a reinforcing filler (see the compound according to the invention MI1) allows simultaneous improvement of the wet grip properties and improvement of the rolling resistance (improvement of the descriptor Tan δ_{max at 23° C.}) compared with a rubber compound of which the phase of lower Tg comprises isoprene elastomer and a reinforcing filler and of which the vulcanization system is based on a usual vulcanization accelerator (see comparative compound MT3). The simultaneous improvement of the wet grip and rolling resistance properties is also observed with the use of another ultra-accelerator of the dithiocarbamate family (compound according to the invention MI2) but not with another vulcanization accelerator (comparative compound MT4).

1.-15. (canceled)

16. A rubber compound having at least two glass transition temperatures Tg1 and Tg2 and based on at least one sulfur vulcanization system and at least two rubber compositions C1 and C2, the rubber composition C1 comprising at least one elastomer E1 and having the glass transition temperature Tg1, the composition C2 comprising at least one elastomer E2, different from the elastomer E1, and a reinforcing filler, and the composition C2 having the glass transition temperature Tg2,
wherein the glass transition temperature Tg1 of the composition C1 is above or equal to −50° C.,
wherein the rubber compound satisfies the mathematical relationship Tg1-Tg2≥23° C.,
wherein the rubber compound has a loss factor profile exhibiting a change in tan δ as a function of a temperature in ° C., the loss factor profile being measured over a temperature range extending from −80° C. to 60° C. at a frequency of 10 Hz and a constant stress of 0.7 MPa and exhibiting one or more peaks, the loss factor profile being such that all tan δ peaks present at a temperature above the glass transition temperature Tg1 have a width at half height below or equal to 23° C.,
wherein the elastomer E1 is predominant in the rubber compound,
wherein the elastomer E2 is an isoprene diene elastomer, and
wherein the sulfur vulcanization system comprises at least one vulcanization accelerator A selected from the group consisting of thiurams, dithiocarbamates, dithiophosphates, xanthates and mixtures thereof.

17. The rubber compound according to claim 16, wherein the rubber compound satisfies the mathematical relationship Tg1-Tg2≥25° C.

18. The rubber compound according to claim 16, wherein the glass transition temperature Tg1 of the rubber composition C1 is above or equal to −48° C.

19. The rubber compound according to claim 16, wherein the glass transition temperature Tg2 of the composition C2 is below or equal to −43° C.

20. The rubber compound according to claim 16, wherein the elastomer E1 of the rubber composition C1 is a diene elastomer selected from the group consisting of polybutadienes, butadiene/styrene copolymers, butadiene/isoprene copolymers, isoprene/styrene copolymers and butadiene/styrene/isoprene copolymers and mixtures thereof.

21. The rubber compound according to claim 16, wherein a content of the elastomer E1 in the rubber compound may be within a range extending from 50 phr to 70 phr.

22. The rubber compound according to claim 16, wherein the isoprene diene elastomer E2 of the rubber composition C2 is selected from the group consisting of natural rubber and synthetic polyisoprene.

23. The rubber compound according to claim 16, wherein the reinforcing filler of the composition C2 predominantly comprises at least one inorganic reinforcing filler.

24. The rubber compound according to claim 16, wherein the vulcanization accelerator A is selected from the group consisting of tetrabenzylthiuram disulfide (TBzTD), tetramethyl thiuram monosulfide (TMTM), tetramethyl thiuram disulfide (TMTD), tetraethyl thiuram disulfide (TETD), tetraisobutyl thiuram disulfide (TiBTD), dipentamethylene thiuram tetrasulfide (DPTT), zinc dibutyl dithiocarbamate (ZDBC), zinc diethyl dithiocarbamate, zinc dimethyl dithiocarbamate, copper dimethyl dithiocarbamate, tellurium diethyl dithiocarbamate (TDEC), zinc diisononyl dithiocarbamate, zinc pentamethylene dithiocarbamate, zinc dibenzyldithiocarbamate (ZBEC), zinc isopropyl xanthate (ZIX), zinc butyl xanthate (ZBX), sodium ethyl xanthate (SEX), sodium isobutyl xanthate (SIBX), sodium isopropyl xanthate (SIPX), sodium n-butyl xanthate (SNBX), sodium amyl xanthate (SAX), potassium ethyl xanthate (PEX), potassium amyl xanthate (PAX), zinc 2-ethylhexylphosphorodithioate (ZDT/S), and mixtures thereof.

25. The rubber compound according to claim 16, wherein the vulcanization accelerator A is selected from the group consisting of tetrabenzyl thiuram disulfide (TBzTD), tetramethyl thiuram monosulfide (TMTM), tetramethyl thiuram disulfide (TMTD), tetraethyl thiuram disulfide (TETD), tetraisobutyl thiuram disulfide (TiBTD), dipentamethylene thiuram tetrasulfide (DPTT), zinc dibutyl dithiocarbamate (ZDBC), zinc diethyl dithiocarbamate, zinc dimethyl dithiocarbamate, zinc diisononyl dithiocarbamate, zinc pentamethylene dithiocarbamate, zinc dibenzyldithiocarbamate (ZBEC), and mixtures thereof.

26. The rubber compound according to claim 16, wherein a content of vulcanization accelerator A is within a range extending from 0.5 to 10 phr.

27. The rubber compound according to claim 16, wherein the at least one sulfur vulcanization system comprises zinc oxide, and a ratio of zinc oxide content, expressed in phr, to a vulcanization accelerator A content, expressed in phr, is within a range extending from 0.05 to 20.

28. The rubber compound according to claim 16, wherein a ratio of a content of sulfur, expressed in phr, to a content of vulcanization accelerator A, expressed in phr, is within a range extending from 0.05 to 24.

29. A pneumatic or non-pneumatic tire tread comprising the rubber compound according to claim 16.

30. A pneumatic or non-pneumatic tire comprising the pneumatic or non-pneumatic tire tread according to claim 29.
